(19) United States
(12) Patent Application Publication
(10) Pub. No.: US 2007/0197160 A1
(43) Pub. Date: Aug. 23, 2007

(54) Music share

(76) Inventors: Kristyn Kelly Health, Fremont, CA (US); Allen Heath, Fremont, CA (US)

Correspondence Address: Kristyn K. Heath, Ste. 700, 4600 South Ulster St., Denver, CO, 80237, US

(21) Appl. No.: 11/700,329

(22) Filed: Jan. 31, 2007

Related U.S. Application Data
(60) Provisional application No. 60/764,273, filed on Feb. 1, 2006.

(51) Int. Cl. H04H 1/00

(52) U.S. Cl. 455/3.05

(57) ABSTRACT

The present invention details a low cost novel apparatus and method of coordinated broadcasting of music among connected peer listeners in a wireless ad-hoc networking environment. One or more receiver/listeners and one or more broadcasting/listeners equipped with a portable music player in local proximity, can use short-range wireless transmission to participate and listen to the same song at the same time. Moreover, the present invention allows listeners in the transmission range to discover broadcasters through channel switching and profile matching. As one broadcaster can have many listeners, channel switching and profile matching are used by the listeners to identify capable broadcasters and by broadcast/listeners to change transmission channels.

### BACKGROUND OF THE INVENTION

1. Field of Invention

The present invention relates to a low cost apparatus and method for music broadcasting. More specifically, the present invention relates to a low cost apparatus and method for coordinated broadcast and radio announcements in local spatial proximity with participants in a wireless ad-hoc network.

2. Description of Related Art

Traditional portable musical entertainment, best exemplified by the IPOD, MP3 Players, Walkman and portable CD players, is usually confined to individual listeners. In general, for a group of music listeners to share mutual music listening, the only way is to play music loudly in an open space or by using a computer to download copies of digital music to other digital players. This allows users to carry the same music but does not synchronize the selections and the users must have the same digital formats for the copies to work. In addition, the cost of digital players is beyond that of many consumers. Playing music out loud in an open space often disturbs other persons, therefore, it is advantageous for music sharers to confine music sharing only to persons who intend to listen.

With leaping advances in wireless networking and digital music technologies such as Bluetooth and MP3 and wireless headsets, portable musical entertainment is now wide spread and can be shared and appreciated simultaneously by more than one person at a lower cost without playing music out loudly. Furthermore, mutual musical entertainment can be appreciated simultaneously only by the sharers who desire to participate.

Prior art relating to music carrying radio lacks the mechanisms and methods to achieve the aforementioned objective. For example, Bottum (U.S. Pat. No. 6,014,569) uses cellular communication systems to deliver asynchronous audio to subscribers. There is no mechanism to ensure synchronous audio reception and broadcast among the logged-on subscribers. Cluts (U.S. Pat. No. 5,616,876) asks user to select songs from a collection to form a preferred song list. The computer server then analyzes this list to suggest more songs similar to user preference. There is no method to suggest how multiple users can match their mutual preference to music. (U.S. Pat. No. 6,757,517) has sophisticated matching profiles and network communications for tuning in that will increase the effective cost of the apparatus and has no resulting way to include personal broadcast comments with the music play back. It also requires music player functions to be controlled by the system in order to achieve synchronization thus preventing music players without an interface from being able to participate. (U.S. Pat. No. 2005 0286546 A1) This method and apparatus requires the use of digital music source (MP3) as apposed to an analog one along with a timer based transmission to synchronize all users receiving the music. This increases the overall complexity and cost of the device and is limited by the underlying protocols required to support it. For example Bluetooth architecture as described is limited by the number of users it can support. The use of Wifi brings with it the requirement to support a digital rights management infrastructure adding to the overall cost of the system. Where as our apparatus and method has no limits or requirements for digital rights management.

### SUMMARY OF THE INVENTION

In view of the foregoing, it is an objective of the present invention to provide a low cost apparatus and method that uses wireless ad-hoc networks to coordinate and broadcast music between the broadcaster and one or more listeners who wish to share music listening.

The present invention details a low cost novel application of wireless networking and digital music technologies to achieve coordinated broadcast music among peer listeners connected by wireless ad-hoc networks. One broadcaster and one or more listeners in local proximity allowed by short-range wireless transmission can participate and listen to the same song at the same time. Moreover, the present invention allows listeners in the transmission range to discover broadcasters through profile matching or frequency selection and to channel switch to other broadcasters and channels. A match indicates a compatible apparatus has been detected. As embodied and broadly described herein, the invention provides a low cost apparatus and method for coordinated broadcast of music in local spatial proximity with wireless ad hoc networks. The broadcast/listening system includes at least one broadcaster and one or more broadcast/listening apparatus used respectively by at least one or more users. The broadcast/listening apparatus with profile matching and channel selecting functionality comprises the following key components: a universal adapter interface for connecting a digital music player, a channel selector, a transmit and receive selector, a volume control selector, a wireless transceiver, a profile storage and matching unit. The broadcast/listening apparatus can operate in at least two modes, listening mode and broadcast mode, for profile matching and channel selection. These two modes constitute two basic and necessary functions.

The low cost apparatus and method for coordinated and synchronized music broadcast in local spatial proximity with wireless ad hoc networks includes the following steps: establishing a wireless ad-hoc network between at least a first apparatus in broadcast mode used by the first user and a second apparatus in listening mode used by the second user; the broadcast apparatus scans and selects a private channel or radio frequency, sends a first message from the first apparatus to a public channel or radio frequency; with a specific profile that identifies the apparatus with a unique identifier and private channel id or specific radio frequency, receiving the first message to the second apparatus and storing the first apparatus unique identifier and perform profile match to see if the identifier is already recorded if so it will not perform switching to the private channel id received from the first apparatus. Additional users in range of wireless ad-hoc network are added using the same method as the second apparatus.

The present invention relates to a low cost apparatus and method for coordinated and synchronized music broadcast in local spatial proximity through wireless ad hoc networks. With the apparatus and method of the present invention, peer listeners can share music listening without playing the music out loud.

The present invention allows listeners in the transmission range to discover a broadcaster through profile matching and radio frequency selection, thereby locating the music based on matched profiles or frequencies. The present invention therefore has potential applications in sociality, merchandising, and marketing to low and medium income persons.

The invention and the attendant advantages thereof will be better understood by reference to the following detailed description when considered in connection with the accompanying figures.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an overview of the three key components of an apparatus in a system according to one preferred embodiment of this invention;

FIG. 2 is an three side overview (SIDE A, SIDE B and SIDE C) of the broadcast/listening apparatus and its operational parts according to one preferred embodiment of this invention;

FIG. 3 is a flow diagram illustrating the processing steps when the system is in the listening mode according to one preferred embodiment of this invention;

FIG. 4 is a functional diagram illustrating various combinations of matching that the user of the listening apparatus may choose to implement according to one preferred embodiment of this invention.

FIG. 5 is a flow diagram illustrating the processing steps when the system is in the broadcasting mode according to one preferred embodiment of this invention.

FIG. 6 is a functional diagram illustrating various combinations of matching and broadcast functions that the apparatus may choose to implement according to one preferred embodiment of this invention.

### DESCRIPTION OF THE PREFERRED EMBODIMENTS

The present invention provides a low cost apparatus and method for providing coordinated and synchronized music broadcast for one broadcast/listener and one or more listeners in local proximity using a portable music player system for applying the aforementioned method.

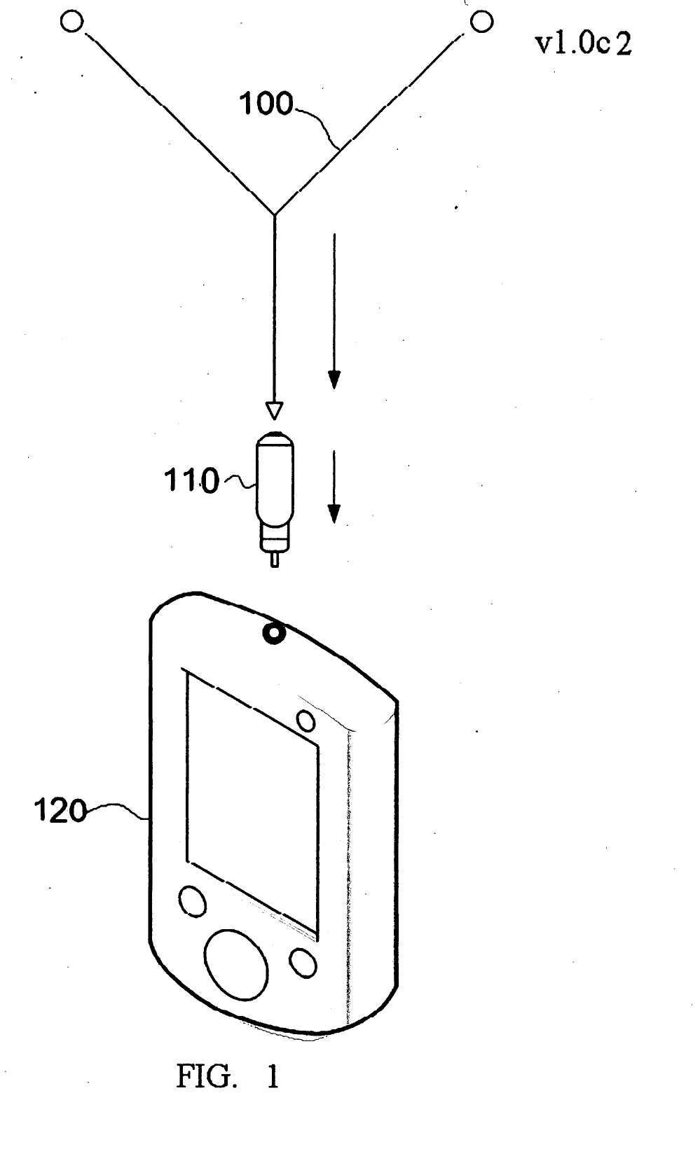

The aforementioned broadcast/listening system includes at least one broadcaster with an apparatus and portable music player and one or more listening apparatuses used respectively by at least one or more users. FIG. 1 illustrates key components of the broadcast/listening system, comprising of a standard earphone system and jack (100), a broadcast/listening apparatus (110) that contains the wireless transceiver which can be implemented by any short-range radio technology, such as but not limited to Bluetooth, FM radio, 2.4 Ghz radio, 802.11, or DECT. and connections for earphone jack in and a earphone jack out (110), a portable music player unit that accepts standard earphone jack (120).

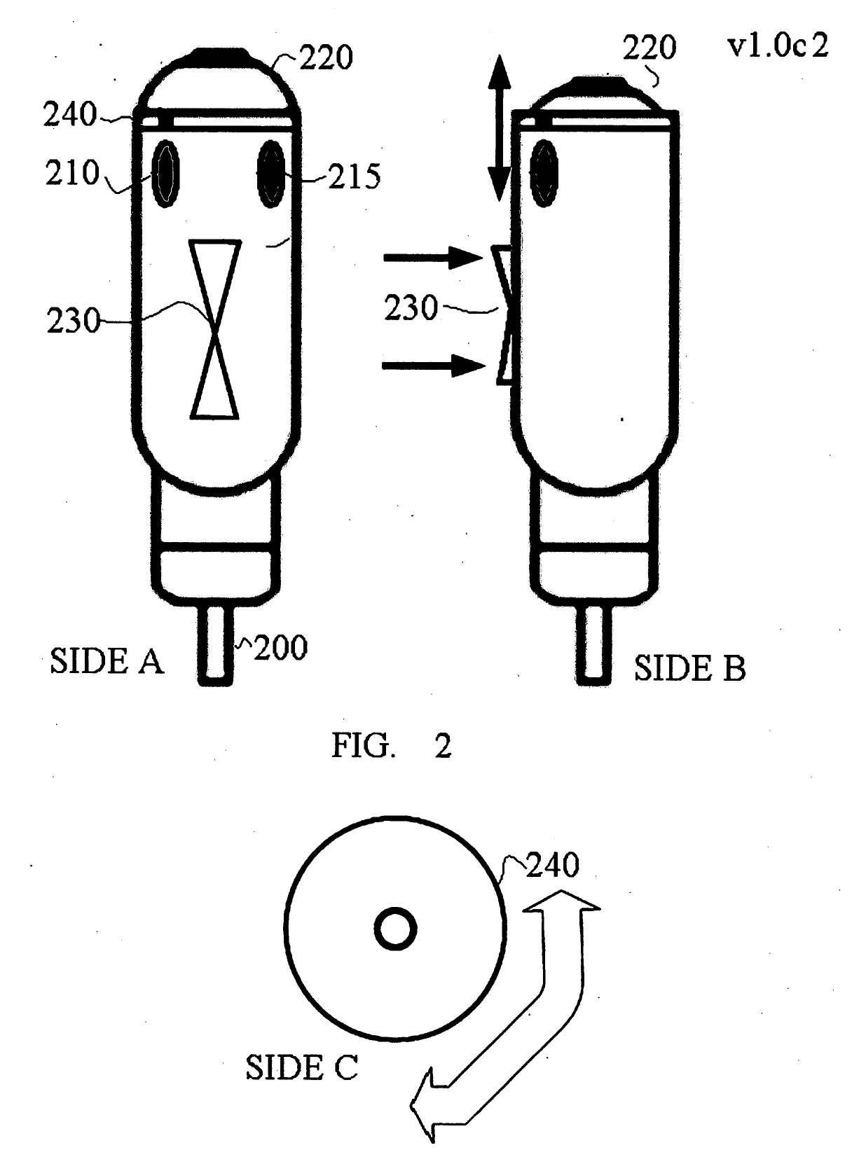

FIG. 2 illustrates 3 sides of the broadcast/listening apparatus that contains a wireless transceiver. SIDE A is a front view and shows the (200) standard earphone jack used to connect to the portable music player for receiving the music output from the player. This interface may be replaced with a cable connection that performs the same function. The transmit indicator (210) that starts message broadcast across the public channel or set radio frequency with its profile for profile matching while continuing to allow the user to hear the music thru their earphones and the receive music indicator (215) that starts the scan for the broadcast message on a public channel while turning off the interface from its portable music player (if one exists) that when the (240) SIDE A control knob above it is turned to indicate and point to its position. The control knob (240) SIDE C (top view) has 2 positions and is turned either right or left to each indicator (210 and 215). Channel switching component (220) SIDE A and SIDE B is depressed to start channel scan. When used during broadcast or when control knob (240) is turned to the broadcast button (210) it causes the transceiver to switch to a new channel. This is used when a user decides there is too much interference on a particular channel. When the channel switch (220) is depressed during receiving or when the control knob (240) is turned to receive (215) it causes the transceiver to scan for a new channel and broadcaster to receive its music broadcast. This can be used to either find a clear channel or select a new broadcaster. The channel switch (220 SIDE B) when depressed will return to its original position (SIDE A) to allow the user to switch multiple times. When the control knob (240) is switched to the receive position all music from the music player if one is attached is shut off as the user will receive its music playback from the wireless ad-hoc network. If no music player exists user can use an optional battery attachment to supply power to the apparatus. Low volume tones are generated as indicators to user a channel search is occurring. Volume is controlled by a rocker switch (230) SIDE B of the apparatus. Upon channel search initiation volume is set to its lowest level. It gives the user additional control of the sound output levels.

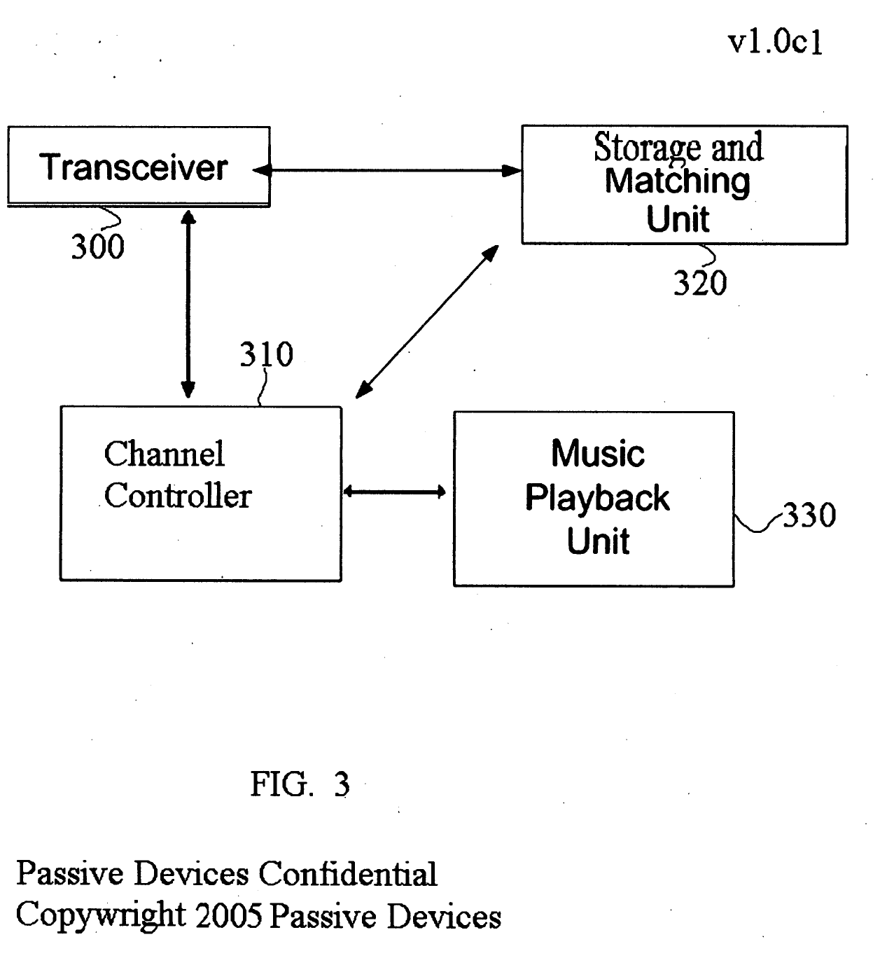

FIG. 3 The transceiver (300) in receive mode constantly listens to a pre-programmed public channel or radio frequency for new, remote parties. The channel controller (310) instructs which channel the wireless transceiver should be sending or receiving messages. The profile storage and matching unit (320) stores the unique id and the channel id of the broadcaster as a local profile and performs matching between the local profile unique id and a received profile unique id from a remote party. For example, an apparatus unique id is set and stored at manufacturing time. The profile matching unit (320) checks the id of a broadcast unit and if a match is found the channel switch process will continue to scan the for a new id. After all channels have been scanned and no new id has been found the user will be returned to the original id and channel. If a new id is found it will use the new channel id as its source for music reception. The music broadcast unit (330) can be a digital or audio device that stores and plays songs. The unit may be implemented based on but not limited to IPOD, MP3, MIDI and other digital audio technologies.

The enhanced broadcast/listening apparatus can operate in at least two or more modes for profile matching. One mode is named “listening mode” while another is named “broadcasting mode”. These two modes constitute two basic and necessary functions.

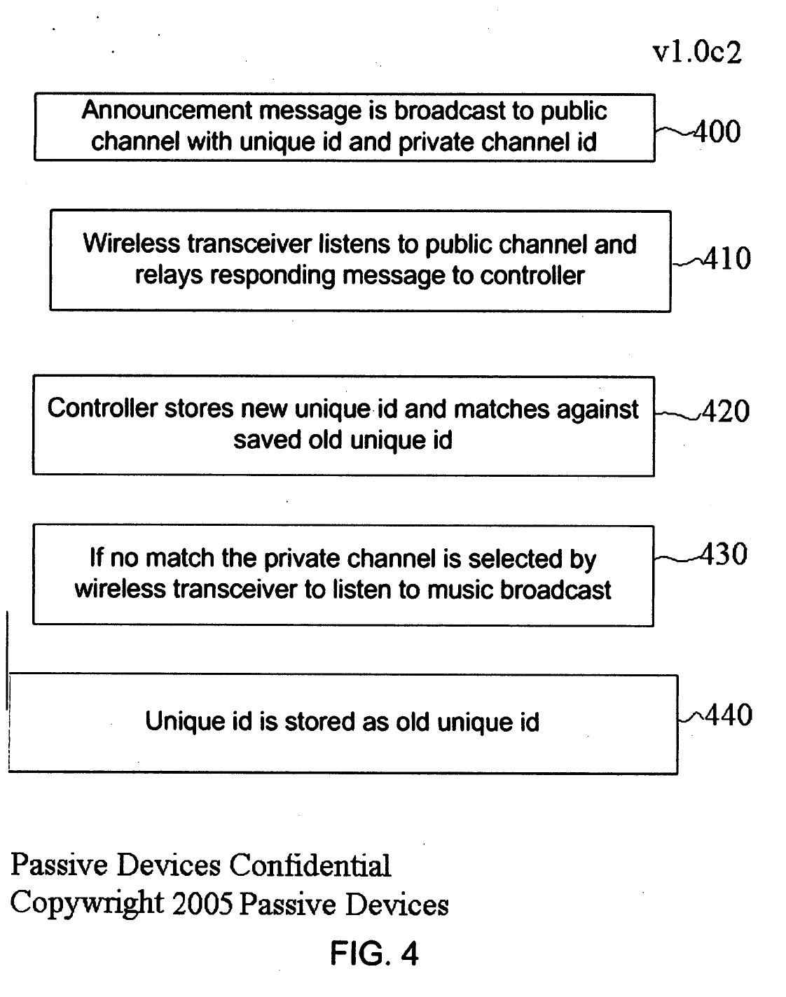

FIG. 4 illustrates the processing steps when the apparatus operates in the listening mode. In this mode, the wireless transceiver scans the public channel for newly joined broadcasters, which send out announcements containing their unique ids and private channel number (400). Messages and announcements are digital data packets like Internet Protocol (IP) packets. or radio text messages. Each apparatus has a factory assigned unique id. The broadcast message from a remote party is relayed to the channel controller (410), which stores and examines the unique id of the remote party looking for a match (420). The channel controller keeps a list of unique ids from recently contacted and failed parties. Failed parties need not be contacted again. If the new unique id is not in the list (430), the channel controller then instructs the wireless transceiver to switch to the private channels provided with the unique id. The channel controller then selects the private channel, and stores the unique id as old unique id (440). Future correspondence between the two parties and broadcast music will use the established private channel.

Multiple parties can receive the broadcast together which is described next.

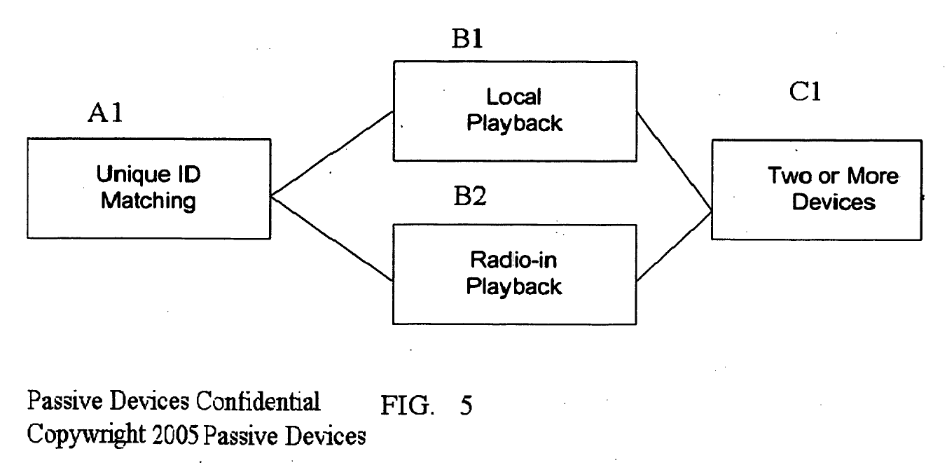

It is noted that the method of this invention for broadcasting music between multiple users can be summarized as combinations according to FIG. 5. FIG. 5 is a functional diagram illustrating various combinations of matching and broadcast functions a listening apparatus may choose to implement. The simplest case of this invention is the combination of A1-B1-C1, as a broadcast/listening system having two broadcast listening apparatuses in local broadcast. This simple scenario is within the scope of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

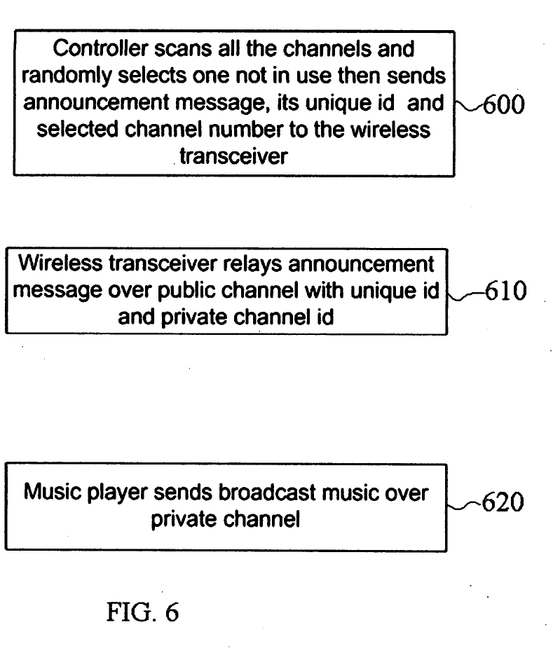

FIG. 6 illustrates the processing steps when the system operates in the broadcasting mode. In this mode, the wireless transceiver first listens to the public channel for broadcast messages from other broadcasters and forwards them, one at a time, to the channel controller (302). For each message, the channel controller retrieves the unique id and private channel and stores it for available channel searching (304). It then scans the channels storage and randomly selects one not in use to be its private channel to broadcast over. It then sends out broadcast message with its own unique id (610) and private channel and starts its broadcast over the private channel. When two or more devices (referred to as the broadcast group) are participating in a broadcast, a new apparatus (used by a new party) may join by responding to the broadcast message from the advertising apparatus. The interactions between the new apparatus and the broadcast apparatus follow the same procedure illustrated in FIG. 3. There is one more step after (310).

It is noted that multi-party synchronized broadcast assumes that at least one song is available on all apparatuses or one device will actively transmit songs over the wireless channel. Enforcing the criterion can be easily imposed by the broadcast device, which stores unique id information.

Music broadcasting can only continue when the system operates in broadcasting mode.

What is claimed is:

1. A low cost apparatus and method for interactively broadcasting music between multiple users, including at least a first user and a second user, comprising the steps of:
establishing a wireless ad-hoc network between at least a first broadcast apparatus with a music player used by the first user and a second listening apparatus used by the second user;
sending a first message from the first apparatus to a public channel or a selected radio frequency;
scanning the public channel or radio frequency and receiving the first message with first profile to the second apparatus; to direct the second apparatus to a private channel or select frequency;
performing matching evaluation between the first profile and a storage area of the second apparatus in the second apparatus to determine if channel selection has already been made
Selecting the private channel or select frequency to receive music
Broadcasting music on the private channel or select frequency from the first apparatus
Receiving music on the private channel or select frequency to the second apparatus

2. The method as claimed in claim 1, wherein after the step of broadcasting music, the method can further include the following steps:
scanning the public channel or radio frequency and receiving the first message with first profile to a third apparatus; to direct the third apparatus to a private channel or radio frequency;
performing matching evaluation between the first profile and a storage area of the third apparatus to determine if channel selection has already been made

3. The method as claimed in claim 1, wherein the step of establishing the wireless ad-hoc network comprises performing short-range radio technologies.

4. The method as claimed in claim 1, wherein the step of sending the first message from the first apparatus comprises sending its unique id and selected private channel or frequency to the second apparatus.

5. A method for interactively broadcasting music between multiple users, including at least a first user with a music player and a second user, comprising the steps of:
establishing a wireless ad-hoc network between at least a first broadcast apparatus used by the first user and a second listening apparatus used by the second user;
sending a first message from the first apparatus to a public channel or radio frequency;
scanning the public channel and receiving the first message with the profile to the second apparatus;
performing matching evaluation between the first message with the profile and a storage area of the second apparatus in the second apparatus to determine if selection has already been made
scanning the public channel and receiving the first message with first profile to a second apparatus; to direct the second apparatus to a private channel or frequency;

6. The method as claimed in claim 5, wherein after the step of broadcasting music, the method can further include the following steps:
scanning the public channel or radio frequency and receiving the first message to a third apparatus used by a third user over the wireless ad-hoc network;
direct the third apparatus to the private channel; and
broadcasting music from the first, to the second and the third apparatuses.

7. The method as claimed in claim 6, wherein the step of establishing the wireless ad-hoc network comprises performing short-range radio technologies.

8. The method as claimed in claim 6, wherein the step of sending the first message from the first apparatus comprises sending a signature of the first apparatus to identify it as a capable device, a unique id and private channel id or radio frequency for the broadcasting apparatus

9. The method as claimed in claim 6, wherein the step of selecting a private channel for first apparatus can be accomplished by listening to the public channel or radio frequency for other broadcasters and storing their private channels and selecting the next available channel or radio frequency.

10. A method for interactively broadcasting music between multiple users, including at least a first user and a second user, comprising the steps of:
establishing a wireless ad-hoc network between at least a first broadcasting apparatus used by the first user and a second listening apparatus used by the second user;
sending a sequence of messages between the first apparatus and the second apparatus;
selecting a broadcaster; and
private channel or radio frequency then broadcasting the song in the apparatuses.

11. The method as claimed in claim 10, wherein the step of exchanging a sequence of messages between the first apparatus and the second apparatus further comprises:
sending a first message from the first apparatus to a public channel;
scanning the public channel and receiving the first message to the second apparatus; and
direct the first apparatus to a private channel or radio frequency.

12. The method as claimed in claim 10, wherein a second broadcaster is selected by second apparatus by receiving the broadcasters message over the public channel or select radio frequency and is directed to the private channel or radio frequency of the second broadcaster

13. The method as claimed in claim 10, wherein after the step of selecting a private channel by broadcasting unit is performed by the first broadcasting listening over the public network

14. The method as claimed in claim 10, wherein the step of sending the first message from the first apparatus comprises sending a first signature of the first apparatus as identification of capable broadcasters

15. The method as claimed in claim 10, wherein the step of establishing the wireless ad-hoc network comprises performing short-range radio technologies.

16. An interactive multi-party linking music listening system comprising at least one listening apparatuses and one broadcasting apparatus communicating over a wireless ad-hoc network, wherein one of the apparatuses is also the first listening apparatus, the first listening apparatus at least comprising:
a first signature to identify the first listening apparatus;
a plurality of channels for communicating between the listening apparatuses, wherein the channels include at least one public channel or radio frequency for advertising the first signature;
a controlled interface for enabling interactive communication over the wireless ad-hoc network;
a channel controller for instructing the channels to be in use and storing signatures of listening apparatuses other than the first listening apparatus;
a wireless transceiver connected to the channel controller, for receiving and sending messages over the wireless ad-hoc network and relaying messages;
a profile storage and matching unit connected to the channel controller, for storing unique id and private channel numbers as a first profile and perform matching between profiles of the listening apparatuses other than the first listening apparatus; and
a music broadcast unit connected to the apparatus, for broadcasting music,
whereby the first listening apparatus can broadcast music with the listening apparatuses other than the first listening apparatus with agreement from all parties.

17. The system as claimed in claim 16, wherein the wireless transceiver is implemented by short-range radio technologies.

18. The system as claimed in claim 16, wherein the wireless transceiver is implemented by a Bluetooth technology.

19. The system as claimed in claim 16, wherein the music broadcast unit comprises a digital music device.

20. The system as claimed in claim 16, wherein the music broadcast unit comprises a MP3 player.

21. The system as claimed in claim 16, wherein the music broadcast unit comprises a stereo output from any stereo headphone.

22. An interactive multi-party linking music listening system comprising at least one broadcast/listening apparatuses and one listening apparatus communicating over a wireless ad-hoc network, wherein one of the broadcast/listening apparatuses is a first listening apparatus, the first listening apparatus at least comprising:
a first signature to identify the first broadcast apparatus;
a plurality of channels for communicating between the listening apparatuses, wherein channels include at least one public channel for advertising the first signature;
a controlled interface for enabling interactive communication over the wireless ad-hoc network;
a channel controller for instructing the channels to be in use and storing signatures of listening apparatuses other than the first listening apparatus;
a wireless transceiver connected to the random access controller, for receiving and sending messages over the wireless ad-hoc network and relaying messages to the random access controller;
a channel selection device that the user uses to accept or reject the listening apparatuses other than the first listening apparatus;
a music broadcast unit connected to the apparatus, for broadcasting music,
whereby the first listening apparatus can broadcast music with the listening apparatuses other than the first listening apparatus with agreement from all parties.

23. The system as claimed in claim 22, wherein the wireless transceiver is implemented by short-range radio technologies.

24. The system as claimed in claim 22, wherein the wireless transceiver is implemented by a Bluetooth technology.

25. The system as claimed in claim 22, wherein the music broadcast unit comprises a digital music device.

26. The system as claimed in claim 22, wherein the music broadcast unit comprises a MP3 player.

27. The system as claimed in claim 22, wherein the user can determine to accept or reject based on a matching for previously selected unique ids.
